(19) United States
(12) Patent Application Publication
(10) Pub. No.: US 2026/0011035 A1
(43) Pub. Date: Jan. 8, 2026

(54) INSPECTING COLORS OF CONTAINERS AFTER PRINTING

(71) Applicant: Applied Vision Corporation, Cuyahoga Falls, OH (US)

(72) Inventors: Eric Matthew Rieman, Cuyahoga Falls, OH (US); Carl Edwin Sebeny, Cuyahoga Falls, OH (US)

(21) Appl. No.: 18/763,663

(22) Filed: Jul. 3, 2024

(51) Int. Cl. G06T 7/90

(52) U.S. Cl. CPC G06T 7/90; G06T 2207/10024

(57) ABSTRACT

A container inspection system is described herein. The container inspection system comprises a camera that captures an image of an exterior surface of the container. The system comprises a processor configured to receive the camera image and retrieve a composite image desirably printed of the exterior surface of the container from a color data file, which further comprising color information related to a printing plate used by a printer to print the composite image on the exterior surface of the container. The processor is configured to transform the received image into a flattened two-dimensional (2D) transformed image of the exterior surface of the container such that the transformed image maps to the composite image with pixels in the transformed image aligned with corresponding pixels in the composite image. The processor is configured to measure color values in the transformed image and output an indication of the measured color values.

### BACKGROUND

Production plants for manufacturing containers (such as beverage cans) can produce a very large number of containers, with sophisticated (multicolor) decoration thereon, in a relatively short amount of time. For instance, a conventional decorator in a container production plant can decorate several thousand containers per minute. Container decorations have intrinsic value, as consumers tend to attach perceptions of quality of product based upon the design on the container that holds the product.

Conventionally, there is a lack of robust inspection of exterior surfaces of containers at these container production plants. A known process for container inspection is tasking an operator at the plant to periodically sample containers from a conveyor for visual inspection. For instance, every so often (e.g., every 15 minutes), the operator may be tasked with pulling a small number of containers off of the conveyor and visually inspecting the containers to ensure that the exterior surfaces of the containers are free of readily apparent defects (e.g., to ensure that proper colors are applied to the exterior surfaces of the containers, to ensure that the exterior surfaces of the containers are free of smears, etc.). Using this conventional approach, hundreds of thousands of defective containers may be manufactured prior to the operator noticing a defect on the exterior surface of one or more of the sampled containers. In practice, these (completed) containers must be scrapped, resulting in significant cost to the container manufacturer.

Visual inspection of labels printed on containers is difficult because the human eye is limited in what it can detect and distinguish. For example, pixel color values cannot be determined by the human eye. Conventional automated approaches to analyzing color on a printed container are laborious and time consuming and have not adequately addressed problems associated with rapid identification of color drift, fading, smearing, pixel aliasing, and the like.

### SUMMARY

The following is a brief summary of subject matter that is described in greater detail herein. This summary is not intended to be limiting as to the scope of the claims.

Described herein is a container inspection system that is configured to measure color values in a captured image of a label printed on a container to facilitate determining whether printer adjustment is needed. According to an embodiment, a color data file is received by the container inspection system. The color data file comprises a composite image (e.g., a correct image) of the label desirably printed on the container as well as color information describing the colors of the inks used to print the label. The inks are deposited on printing plates, where each printing plate has a plurality of keys disposed thereon and each key is associated with a single key ink color. Using the information in the color data file, the container inspection system knows a priori where each ink color occurs in the composite image at a pixel level. The container inspection system includes a camera that captures an image of an exterior surface (e.g., a sidewall) of a printed sample container for use in determining pixel color values in the captured image. The container inspection system performs pixel color analysis for each key ink color used to print the label as determined from the color data file. According to an example, the container is cylindrical. The camera captures a line scan image (e.g., the camera scans an image printed on the container line by line as the container is rotated in front of the camera), which is an “unwrapped” two-dimensional version of the image on the cylindrical container.

The container inspection system includes a computing system that receives the captured image from the camera and applies a transform to the captured image to transform or map the captured image to the composite image. The transformation ensures that pixels in the two-dimensional transformed image are aligned with their corresponding pixels in the composite image, which avoids pixel aliasing. Pre-processing of the captured image may comprise copying, removing, replacing, etc., pixels in the captured image, shifting and/or conditioning the captured image, etc., to ensure the image can be transformed properly. The computing system performs pixel color analysis to detect pixel color (e.g., red-green-blue-white (RGBW), cyan-magenta-yellow-key (CMYK), etc.) values for each key ink color applied to each key on each printing plate during printing. Because the computing system has a priori knowledge of the key ink colors used and the regions within the composite image where each key ink color was deposited, the computing system can determine which regions of the transformed image to sample for a given key ink color.

Sampling pixels in the transformed image can comprise sampling regions in the transformed image where a given key ink color is known to have been used to print the composite image, since the composite image and the transformed image are aligned and mapped to one another. Sampled pixel color values can then be manipulated to generate an output pixel color value for each key ink color in the color data file. For example, for a given key ink color, the sample pixel color values can be averaged to generate the output pixel color value. In another embodiment, a median pixel color value can be calculated for the sample pixel color values for each key ink color.

According to another aspect, a method of inspecting a label printed on a container is provided. The method can include capturing an image of a container having the label printed thereon and providing the captured image to a computing system that transforms the captured image to align pixels in the transformed image with pixels in the composite image retrieved from the color data file received from the printer. The color data file also includes plate and key color information for printing plates used to print the label on the container.

Taking a cylindrical container as an example, when printing the label on the container, a plurality of printing plates each comprising a plurality of keys are employed to transfer ink to a “blanket” over which the container is rolled during printing. A single ink color is applied to each key on each printing plate. Some keys may be left devoid of ink, some keys may employ a common color of ink, etc. Each printing plate has etched thereon a portion of the image to be printed on the container. The combination of the ink colors employed on the keys of the printing plates, once printed, results in a complete composite image. The color data file for the composite image is included in the color data file received by the computing system of the inspection system and is retrieved by the computing system during transformation of the camera image when aligning pixels between the transformed camera image and the composite image.

The method further includes measuring color values in the transformed image, where in the measurement is performed for each key ink color described in the color data file. The position of pixels of a given key ink color can also be derived from the color data file because the location of each key on each printing plate is known. Pixels of each key ink color can be sampled in the transformed image during measurement because their location is known from the color data file. For a given key ink color, an output pixel value is generated. In one embodiment, the output pixel value is an average of the pixel color values of the sample pixels. In another embodiment, the output pixel value is a median pixel color value for the sample pixels. The output pixel value for each key ink color can be provided to the printer or printing facility.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a schematic of an exemplary container inspection system.

FIG. 2 is an illustration of the plates with keys disposed thereon.

FIG. 3 is an illustration of a roller around which a printing plate has been wrapped for ink transfer onto a blanket for subsequent transfer to a container.

FIG. 4 is an illustration depicting a workflow between various components of the inspection system.

FIG. 5 illustrates an exemplary methodology for configuring a container inspection system.

FIG. 6 illustrates an exemplary methodology that facilitates operating a container inspection system.

FIG. 7 is an exemplary computing device.

### DETAILED DESCRIPTION

Various technologies pertaining to a container inspection system are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Further, as used herein, the term “exemplary” is intended to mean serving as an illustration or example of something and is not intended to indicate a preference.

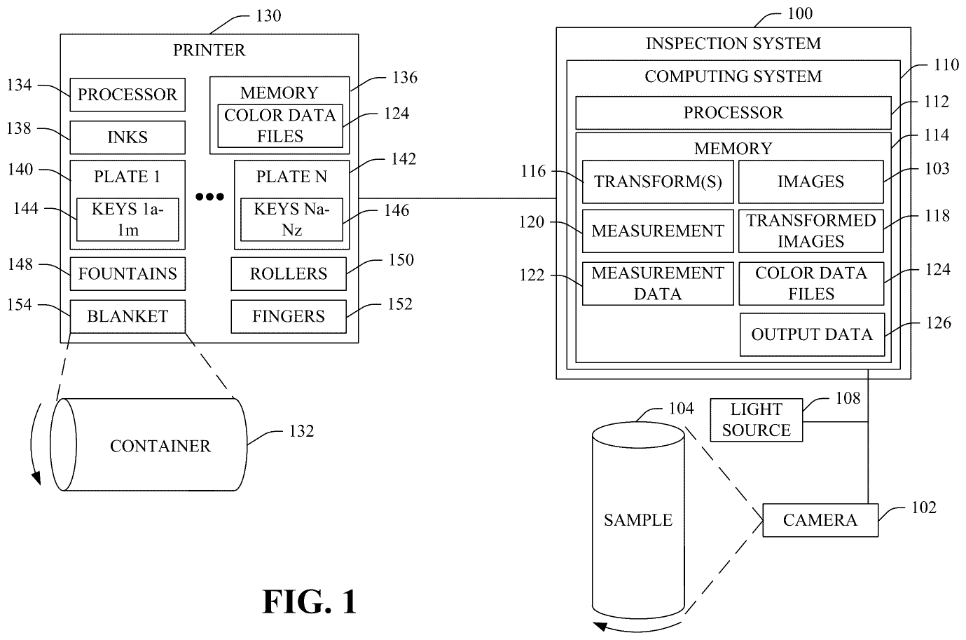

With reference now to FIG. 1, an exemplary container inspection system 100 is illustrated. The following description uses cylindrical containers as one example of containers that can be inspected. However, one of skill in the art will appreciate that containers of any shape can be inspected using the herein described techniques, methods, etc. Moreover, the described techniques, methods, etc. are not limited to use and inspecting containers, but rather can be employed to inspect any desired object.

Generally, the container inspection system 100 is configured to inspect exterior surfaces of sidewalls of containers and measure pixel values for one or more colors printed thereon. The container inspection system 100 includes or is coupled to a camera 102 configured to capture images 103 of a sample container 104. A light source 108 is also provided for illuminating the sample container 104 during image capture. One or more of the camera 102 and the light source 108 can be integral to the inspection system. In another embodiment, one or more of the camera 102 and the light source 108 are external to the inspection system and operatively coupled thereto. In one embodiment, the sample container 104 is positioned on a turntable (not shown) and rotated about its center axis while the camera 102 captures a 360° image 103 of the exterior sidewall surface of the sample container 104.

The container inspection system 100 further includes a computing system 110 that is in communication with the camera 102 and the light source 108. The camera 102 is in communication with the computing system 110 and is controlled by the computing system 110. More particularly, the computing system 110 causes the camera 102 to capture an image of the exterior surface of the sidewall of the container sample 104 while the exterior surface is being illuminated by way of the light source 108. In other words, the camera 102 generates an image of the exterior surface of the sidewall of the container sample 104 when such surface is illuminated. The camera 102 then provides the image to the computing system 110, and the computing system 110 generates output information describing the colors printed on the container sidewall based upon the image 103 generated by the camera 102.

The computing system 110 causes the light source 108 to illuminate when the inspection system 100 is activated. The light source 108 can be, e.g., a light emitting diode, a plurality of light emitting diodes arranged in a ring, a matrix of light emitting diodes, etc.

The computing system further comprises a processor 112 that executes, and a memory 114 that stores, computer-executable instructions for performing the various methods, techniques, functions, etc., described herein. The memory 114 includes a transform component 116 configured to transform an image 103 captured by the camera 102 into a two-dimensional flattened (transformed) image 118 of the cylindrical container sidewall. The transform component 116 can apply one or more transforms to the image 103 captured by the camera 102 to generate the transformed image 118. The transform component 116 causes the image 103 to be modified by applying the transform(s) such that the transformed image 118 that is outputted maps to a composite image (e.g., a correct image) desirably printed on the sidewall of the container sample 104.

The computing system 110 receives the images of the container sample 104 generated by the camera 102 and generates a transformed image 118, which is aligned with the composite image. The computing system 110 further includes a color measurement component 120 configured to measure pixel color values in various sections, regions, quadrants, areas, etc., corresponding to respective key ink colors in the transformed image 118. The color measurement component 120 outputs color measurement data 122 that specifies the measured pixel color values. Further, the color measurement data 122 can be stored in the memory 114. The container sample 104 can then be removed from the inspection system 100.

The color data files 124 stored in the memory 114 of the inspection system 100 are color data files used by a printer 130 to print colors on containers 132 (e.g., cylindrical containers in the described example). The printer 130 comprises a processor 134 configured to execute, and a memory 136 that stores, computer executable instructions related to printing images on containers. The printer 130 can be an offset printer, a dot matrix printer, or the like, although other types of printers are contemplated. The color data files 124 are also stored in the printer memory 136, and describe the colors, amounts, and locations (plates and keys) where the colors are to be applied to the printing plates that are used to transfer ink. The printer 130 therefore comprises one or more inks 138 that are applied to the plates for ink transfer. The printer 130 also comprises a first plate 140 and may comprise up to an Nth plate 142, where N is an integer greater than 1. Each plate comprises one or more keys 144, 146, which are bands within which a single color is applied to the plate. For example, the first plate 140 can comprise keys 1a through 1m, where m is an integer greater than 1. The Nth plate 142 can comprise keys Na through Nx, where x is an integer greater than 1. In one embodiment m and x are equal to each other. In another embodiment, m and x are not equal to each other. The inks 138 are applied by one or more ink fountains 148 to one or more plates 140, 142 disposed on respective rollers 150 at prescribed locations or regions (keys). A plurality of “fingers” 152 apply pressure to the rollers 150 when transferring the inks on a blanket 154 at a desired thickness. Once the inks 138 are transferred to the blanket 154, the blanket 154 comprises an inverse of the image to be transferred to the container 132. The inks 138 are then transferred from the blanket 154 to the container 132. In the case of a cylindrical container, the container is rolled over the blanket to transfer the image to the container.

The color data files 124 used by the printer 130 are received by the inspection system 100 prior to inspection. The color data files 124 may include, e.g., images (e.g., tag image file format (TIFF) or some other suitable image type) of each individual plate 140, 142, as well as a composite image showing the individual plate images overlaid on top of each other and representing the image that is printed on the cylindrical container. The color data files 124 additionally include information about the position of the keys 144, 146 on the respective plates 140, 142, as well as the location of fountains 148 in relation to the plates so that color can be measured for each plate in each fountain 148. Once the colors in the transformed image 118 are measured, output data 126 is generated. For instance, the output data 126 can be provided to the printer 130. In one embodiment, the output data 126 includes the color value measurement data 122 (e.g., average, median, etc.) for each key on each plate 140, 142. The output data 126 can be used to identify which fountains 148 that deposit ink on the printing plates need to be adjusted, which fingers 152 require a pressure adjustment, etc.

In one embodiment, the printer 130 and the inspection system 100 are communicatively coupled (e.g., wirelessly or by cable or the like) and the inspection system 100 receives the color data files 124 directly from the printer 130. In another embodiment, the color data files 124 are retrieved from the printer 130 and manually transferred (e.g., downloaded) to the inspection system 100. According to an example, the printer 130 may have, e.g., seven different printing plates, each comprising, e.g., 4 keys for a total of up to 28 different colors to be applied to the blanket 154, which is then applied to the container 132 to print an image thereon. The printing facility may run the printer 130 for a predefined period of time or number of prints. Periodically, a sample container 104 can be taken from the assembly line and placed in the inspection region of the inspection system 100.

Color defects in the image (e.g., a label) printed on the container can occur when insufficient pressure is applied to the plates as they are inked, when insufficient pressure is applied to the plates as they deposit ink on the blanket, when insufficient pressure is applied during ink transfer from the blanket to the container, etc. Color defects can also occur when too much pressure is applied during the ink transfer to or from the plates, blanket, and container. Still other color defects can occur during a container labeling run due to different fade rates of different colors. For example, one color may fade or wear off of a plate more quickly than another color. To combat this problem, the same plate can be used on two different rollers to apply the quickly fading color to the blanket more than one time. However, this solution has the drawback that the color can be over-deposited during early stages of a labeling run.

The camera 102 captures a high resolution 360° image of the exterior sidewall of the sample container 104. In one example, the camera 102 is a line scan camera that scans an image or label on the exterior sidewall of the sample container line by line as the sample container is rotated in front of the camera to generate an unwrapped image of the sidewall of the sample container. The processor 112 executes one or more transforms on the captured image 103 to align the captured image with the composite image provided in the color data file 124. The measurement component 120 analyses the transformed image 118 to identify color values for pixels therein. For each key of each plate, the measurement component 120 measures a color value. In one embodiment, the measurement component 120 identifies the output color value by calculating an average pixel color value for each key. In another embodiment, the measurement component 120 identifies the output color value by calculating a median pixel value in each key region. In yet another embodiment, the measurement component 120 identifies the output color value by calculating one or more standard distribution pixel values for each key. The identified color values for each key are then stored as measurement data 122. This information can be included in an output signal that is provided back to the printer for adjusting printer components (e.g., automatically or manually).

Periodically, the inspection system 100 may receive a label change command that informs the inspection system 100 that a new label is going to be printed on the container. The label change command includes or is followed by a new color data file 124 including images of the plates used to print the new label and/or color information for all plates and keys used to create the composite image. Similarly, when the printer 130 components (e.g., ink fountains, fingers that apply pressure to the rollers during ink transfer, etc.) are adjusted to correct for differences noted in the output data, the inspection system 100 can receive an updated color data file 124 including updated composite image, plate, and key color information, which can be used for subsequent measurement of pixel color values.

Alternate examples of the described inspection system are also contemplated. For example, the container inspection system 100 can include multiple cameras 102 positioned around the container sample 104 when the container is in the inspection region (e.g., when the exterior sidewall of the container is illuminated by the light emitted from the light source 108). For instance, the container inspection system 100 can include two cameras, three cameras, four cameras, or more, such that the cameras 102 generate images 103 encompassing an entirety of an exterior surface of the sidewall of the container 104. The multiple images can then be stitched together using known techniques. In another example, one or more sensors can be employed in or near an inspection region of the inspection system to facilitate automated activation of the inspection system upon detection of a sample to be imaged.

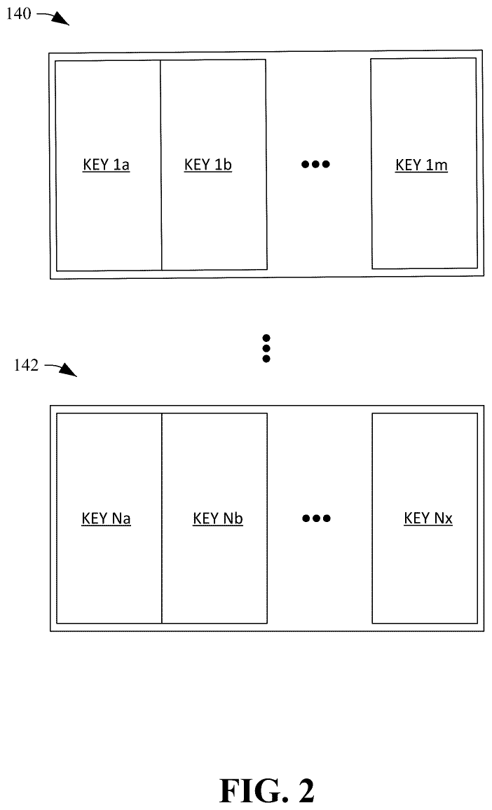

FIG. 2 is an illustration of the plates 140, 142 with keys disposed thereon, in accordance with one or more features described herein. A first plate 140 comprises a plurality of key regions disposed thereon, including key 1a, key 1b, up to key 1m where m is an integer greater than b. Similarly, an Nth plate 142 comprises a plurality of key regions disposed thereon, including key Na, key Nb, up to key Nx where x is an integer greater than b. The plates 140, 142 on which the ink is laid can be formed of a flexible material so that they can be bent around or otherwise disposed on a cylindrical roller in order to transfer the ink to a blanket for subsequent transfer to a container. Each key on each plate can have deposited thereon a single color of ink. Each plate need not have the same number of inked keys (e.g., some plates may include keys that are not inked, some plates may include different numbers of keys, etc.). Additionally or alternatively, some keys on a single plate may have the same color ink disposed thereon. In another embodiment, keys on different plates may have a common color disposed thereon.

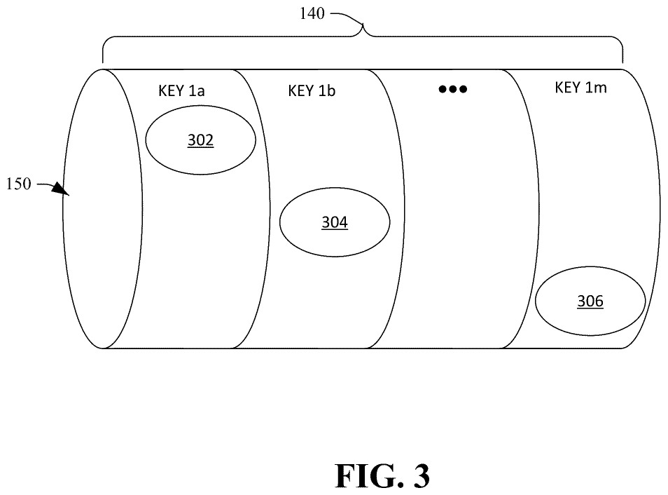

FIG. 3 is an illustration of a roller 150 around which plate 140 has been wrapped for ink transfer onto a blanket for subsequent transfer to a container. The plate includes m keys (labeled 1a-1m) where m is an integer greater than 1. Key 1a has a first ink 302 of a first color deposited thereon. Key 1b as a second ink of a second color 304 deposited thereon. Similarly, key 1m has an mth ink of an mth color 306 deposited thereon. As the roller 150 is rolled over a blanket (see FIG. 1), the inks 302, 304, 306 are deposited on the blanket at prescribed locations. Information regarding the location of the keys on the plate 140 and/or the location of the inks deposited on the respective keys can be included in the color data file (see FIG. 1) received by the inspection system 100. This information can be included in the color data file for each key on each plate used to print a label or image on the container.

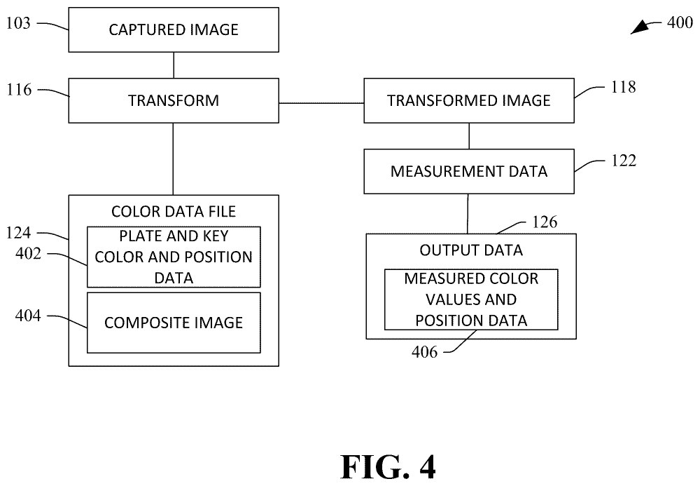

FIG. 4 is an illustration depicting a workflow 400 between various components of the inspection system 100 (FIG. 1), in accordance with one or more features described herein. The transform component 116 receives a captured image (e.g., from the camera 102, not shown in FIG. 4). The color data file 124 is also provided and includes plate and key color and position data 402 as well as the composite image 404 of the label applied to the container. The transform component 116 executes one or more transforms on the captured image 103 to align pixels of the composite image 404 with pixels in the transformed image 118. In one embodiment, the transform includes generating and applying a homography matrix when transforming the captured image. The homography matrix is generated by the computing system 110 by identifying matching features in the captured image 103 and the composite image provided in the color data file 124. Color values for pixels in the transformed image 118 are measured to generate color value measurement data 122. The measurement data 122 is used to generate output data 126, which includes measured color values and position data 406. The output data 126 can be used to perform any necessary adjustments to printer components to correct for out-of-tolerance pixel color values.

According to various examples, the transform component 116 can implement a homography technique to generate the transformed image 118. An illustration of an exemplary homography technique that can be employed by the transform component 116 follows. Following this illustration, the captured image 103 (e.g., an acquired Deco-Match image) can be transformed to match a size of an ideal plate image (e.g., the composite image 404) using a two-row by three-column affine transformation matrix (A) (also referred to as a homography matrix). Each pixel location (P) of the ideal image can be transformed to a modified location within the acquired Deco-Match image (D) according to the equation D=AP, where both D and P are two-dimension vectors containing the row and column locations within the corresponding images. The six parameters for the matrix (A) are determined by finding at least four (and possibly more) feature locations within the ideal plate image that match corresponding feature locations within the Deco-Match image. Features within the two images are found using the SIFT (scale invariant feature transform) algorithm. It is contemplated, however, that not all found features are matching features. Moreover, the RANSAC (random sample consensus) algorithm can also be used to filter the feature points and retain feature point pairs (e.g., one feature from the Deco-Match image and the other from the ideal plate image) that are likely to be matching features (e.g., with a likelihood above a threshold). The six values for the matrix (A) can be computed from the location vectors of the retained matching points using the least square method.

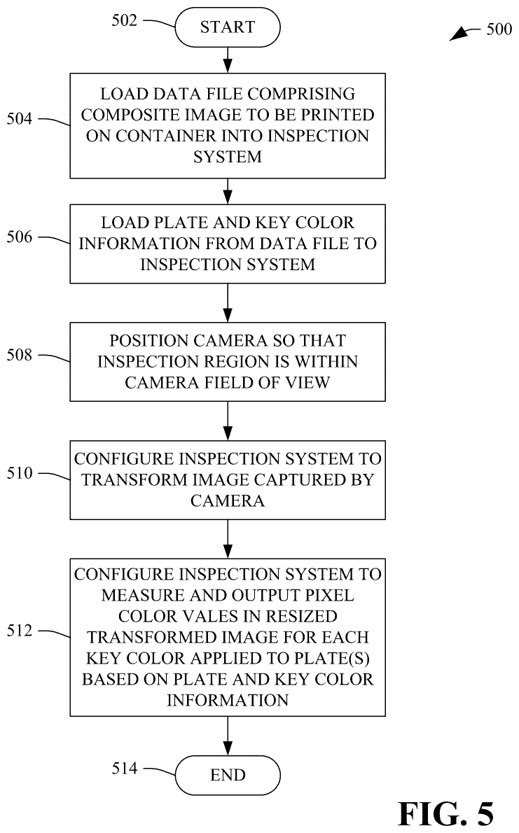

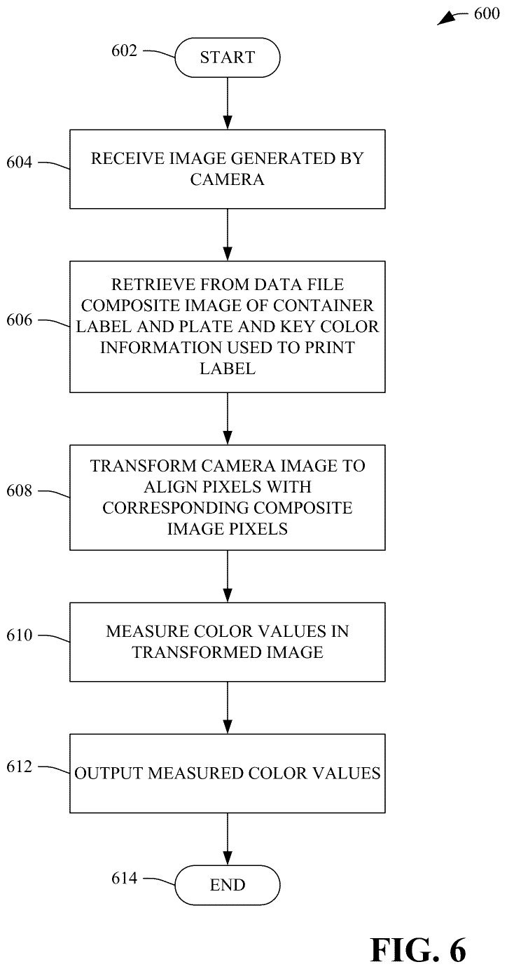

FIGS. 5-6 illustrate exemplary methodologies relating to configuring and operating a container inspection system. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Now referring to FIG. 5, an exemplary methodology 500 for configuring a container inspection system is illustrated. The methodology 500 starts at 502, and at 504, a data file comprising a composite image of a label to be printed on a container is loaded into the inspection system. At 506, information pertaining to printing plates used to print the label on the container, keys disposed on the printing plates, and ink colors associated with the respective keys is loaded into the inspection system. At 508, a camera comprised by the inspection system or otherwise coupled thereto is positioned so that an inspection region of the inspection system is within a field of view of the camera. In one embodiment, the container is cylindrical and is rotated in front of the camera, and the camera scans an entire external surface or sidewall of the container to generate an image.

At 510, the inspection system is configured to transform the image captured by the camera. Transformation of the captured image can include applying a homography matrix to the captured image to align pixels in the transformed image with pixels in the composite image. At 512, the inspection system is configured to measure and output pixel color values in the transformed image for each key color applied to the plates based on the plate and key color information in the color data file. Pixel color measurement can include sampling pixels in key regions of the transformed image, determining RGB values for the sample pixels in a given key region, and averaging the RGB values for the sampled pixels in the given key region. “Region” as used herein refers to areas of the transformed image that are known to include pixels of a given key ink color as determined from the composite image and the plate and key color information in the color data file. The average RGB value for each region can then be output. In another embodiment, a median value is calculated for the RGB values for the sample pixels in a given key region, and the median RGB value is output. The methodology 500 completes at 514.

Referring now to FIG. 6, an exemplary methodology 600 that facilitates operating a container inspection system is illustrated. The methodology 600 starts at 602, and at 604 an image of a container generated by a camera is received. At 606, a composite image of a label printed on the container is retrieved from a data file, along with color information for inks disposed on one or more keys on one or more plates used to print the label on the container. At 608, the camera image is transformed to align pixels in the transformed image with corresponding pixels in the retrieved composite image. This feature prevents aliasing of pixels prior to color value measurement. At 610, color values are measured for pixels in the transformed image. Measurement of pixel color values can include sampling pixels in a predefined key region of the transformed image and averaging the pixel color values for the sampled pixels. The average pixel color value for the sampled pixels in the predefined key region can be used as the measured color value for the predefined key region. In another embodiment, a median color value for sampled pixel color values of a given key region can be determined and used as the measured pixel color value for the key region. At 612, measured pixel color values for all key regions of the transformed image are output. Color value measurement can be performed for each key of each plate, where respective keys each comprise a single respective ink color. The methodology 600 completes at 612.

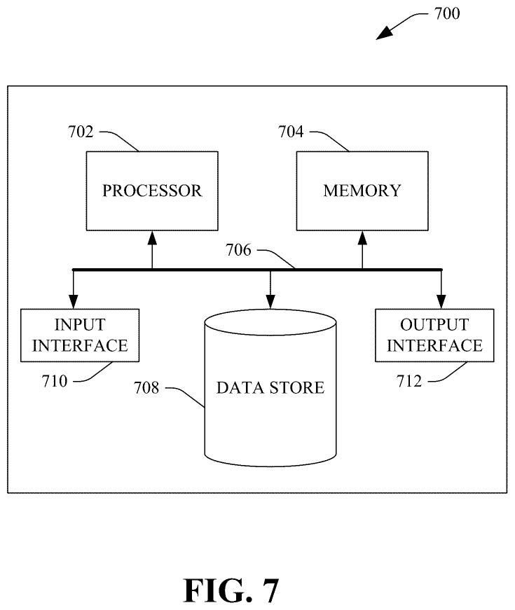

Referring now to FIG. 7, a high-level illustration of an exemplary computing device 700 that can be included in the computing system 110 is illustrated. The computing device 700 includes at least one processor 702 that executes instructions that are stored in a memory 704. The instructions may be, for instance, instructions for implementing functionality described as being carried out by the computing system 110, as described above. The processor 702 may access the memory 704 by way of a system bus 706. In addition to storing executable instructions, the memory 704 may also store images, threshold values, etc.

The computing device 700 additionally includes a data store 708 that is accessible by the processor 702 by way of the system bus 706. The data store 708 may include executable instructions, images, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

It is contemplated that the external devices that communicate with the computing device 700 via the input interface 710 and the output interface 712 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 700 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 700 may be a distributed system. Thus, for instance, several devices may be in communication by way of a network connection and may collectively perform tasks described as being performed by the computing device 700.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A container inspection system comprising:
a camera that is configured to capture an image of an exterior surface of a container;
a computing system comprising a memory that stores computer-executable instructions that, when executed by a processor, cause the processor to perform acts comprising:
receiving the image captured by the camera;
retrieving a composite image desirably printed on the exterior surface of the container from a color data file, the color data file comprising the composite image and color information related to a printing plate used by a printer to print the composite image on the exterior surface of the container;
transforming the received image into a flattened two-dimensional (2D) transformed image of the exterior surface of the container such that the transformed image maps to the composite image, wherein pixels in the transformed image align with corresponding pixels in the composite image;
measuring pixel color values in the transformed image; and
outputting an indication of the measured pixel color values.

2. The container inspection system of claim 1, wherein the color information comprises color information for a plurality of printing plates, each printing plate having a plurality of keys, each key being associated with a single key ink color.

3. The container inspection system of claim 2, wherein measuring the pixel color values further comprises the act of, for each key ink color, sampling pixel color values in the transformed image and generating an output pixel color value based on the sampled pixel color values.

4. The container inspection system of claim 3, wherein the act of sampling is performed for each key ink color in a transformed image region corresponding to a composite image region where the key ink color was deposited, as indicated by the color information in the color data file.

5. The container inspection system of claim 4, wherein for each key ink color the output pixel color value is one of an average pixel color value and a median pixel color value of the sampled pixel color values.

6. The container inspection system of claim 1, wherein the act of transforming the received image is performed using a homography matrix.

7. The container inspection system of claim 1, the container being rotated during image capture.

8. The container inspection system of claim 1, wherein the container is cylindrical.

9. The container inspection system of claim 1, further comprising a light source configured to illuminate the exterior surface of the container during image generation.

10. The container inspection system of claim 1, when the light source comprises one or more light emitting diodes (LED).

11. The container inspection system of claim 1, the acts further comprising transmitting the output pixel color values for each key ink color to the printer.

12. A method for operating a container inspection system, the method comprising:
receiving an image of an exterior surface of a container generated by a camera;
retrieving a composite image desirably printed on the exterior surface of the container from a color data file, the color data file comprising the composite image and color information related to a printing plate used by a printer to print the composite image on the exterior surface of the container;
transforming the received image into a flattened two-dimensional (2D) image of the exterior surface of the container such that the transformed image maps to the composite image, wherein pixels in the transformed image align with corresponding pixels in the composite image;
measuring pixel color values in the transformed image; and
outputting an indication of the measured pixel color values.

13. The method of claim 12, wherein in the color information comprises color information for a plurality of printing plates, each printing plate having a plurality of keys, each key being associated with a single key ink color.

14. The method of claim 13, wherein measuring the pixel color values further comprises the act of, for each key ink color, sampling pixel color values in the transformed image and generating an output pixel color value based on the sampled pixel color values.

15. The method of claim 14, wherein the act of sampling is performed for each key ink color in a transformed image region corresponding to a composite image region where the key ink color was deposited, as indicated by the color information in the color data file.

16. The method of claim 15, wherein for each key ink color the output pixel color value is one of an average pixel color value and a median pixel color value of the sampled pixel color values.

17. The method of claim 12, wherein transforming the received image is performed using a homography matrix.

18. The method of claim 12, the container being cylindrical and further comprising rotating the container during image capture.

19. The method of claim 12, further comprising transmitting the output picture color values for each key ink color to the printer.

20. A method for configuring a container inspection system, comprising:
loading into the container inspection system a color data file comprising a composite image of a label desirably printed on a container and key ink color information describing ink colors applied to respective keys on printing plates used to print the label;
positioning a camera so that an inspection region of the inspection system is within a field of view of the camera;
configuring the inspection system to transform an image captured by the camera; and
configuring the inspection system to measure and output pixel color values in the transformed image for each key color in the color data file.
